(19) United States
(12) Patent Application Publication
(10) Pub. No.: US 2006/0283289 A1
(43) Pub. Date: Dec. 21, 2006

(54) Harmonic drive motor with flex-spline interlock

(76) Inventors: Thomas A. Baudendistel, Farmersville, OH (US); Ronald G. Smith JR., New Carlisle, OH (US); Harald Klode, Centerville, OH (US)

Correspondence Address: DELPHI TECHNOLOGIES, INC., M/C 480-410-202, PO BOX 5052, TROY, MI, 48007, US

(21) Appl. No.: 11/450,883

(22) Filed: Jun. 9, 2006

Related U.S. Application Data
(60) Provisional application No. 60/691,144, filed on Jun. 16, 2005.

(51) Int. Cl. F16H 35/00

(52) U.S. Cl. 74/640

(57) ABSTRACT

A harmonic drive motor includes a first annular member, concentric second and third members, and a device for flexing the first annular member. The first annular member has a longitudinal axis and is flexible. The second member is relatively rigid and is substantially coaxially aligned externally of the first annular member, and the third member is relatively rigid and is substantially coaxially aligned internally of the first annular member. One of the second and third members is rotatable about the longitudinal axis and the other is relatively non-rotatable. The flexing device flexes the first annular member into at least two spaced-apart points of contact with the inner diameter surface of the second member and into at least two spaced-apart points of contact with the outer diameter surface of the third member. The flexing device sequentially flexes the first annular member to rotate both sets of at least two points of contact about the longitudinal axis which effects relative rotation between the second and third members.

### RELATED PATENT APPLICATIONS

This application claims priority to U.S. provisional patent application Ser. No. 60/691,144 filed 16 Jun. 2005, entitled “Harmonic Linear Actuator and Flexing Splined Interlock for Harmonic Motor or Linear Actuator”. This application is also related to U.S. application Ser. No. 11/412,057 filed 26 Apr. 2006, entitled “Harmonic Drive Linear Actuator”, the specification of which is expressly incorporated herein by reference.

### TECHNICAL FIELD

The present invention relates generally to motors, and more particularly to motors employing harmonic drives.

### BACKGROUND OF THE INVENTION

Motors include harmonic motors. One type of harmonic motor has a rotatable rotor and a surrounding nonrotatable stator. The rotor makes a single point of contact with the inner circumference of the stator. The single point of contact rotates around (i.e. rolls around) the inner circumference of the stator. The rotor rotates a few degrees about its longitudinal axis for each complete rotation of the single point of contact about the inner circumference of the stator. In one modification, the outer circumference of the rotor and the inner circumference of the stator have gear teeth. Such motors find use in high torque, low speed motor applications. In one known variation, the rotatable rotor is above a nonrotatable stator, and the rotatable rotor flexes or wobbles downward to make a single point of contact with the stator, the single point of contact rotates around an “inner circumference” of the stator, and the rotor rotates a few degrees about its longitudinal axis for each complete rotation of the single point of contact. In another type of harmonic motor, a shaft is surrounded by a shaft-driving member, which is brought into a single point of contact with the shaft by electro-restrictive devices, wherein the rotor rotates a few degrees for each complete rotation of the single point of contact around an inner circumference of the shaft-driving member.

Harmonic motors are generally used to impart rotary motion, and may be of the type described in, for example, U.S. Pat. No. 6,664,711 B2 entitled “Harmonic Motor”, the disclosure of which is expressly incorporated herein by reference. Such motors employ a first, flexible annular member provided with gear teeth that are engagable with gear teeth of a second member surrounding or surrounded by the first annular member, the first annular member actually being cup-shaped as described herein below, and also referred to as a flex-tube.

Harmonic drive gear trains are known. In one known design, a motor rotates a “wave generator” which is an egg-shaped member, which flexes diametrically opposite portions of the surrounding flex-spline gear, which is inside an outer gear. As the diametrically opposite teeth of the flex-spline gear contact the teeth on the outer gear, the rotatable one of the gears rotates with respect to the nonrotating one of the gears.

Currently, the only method of preventing rotation of the annular flexible member in a harmonic motor or actuator is to configure the member to have a generally cylindrical body with opposite open and closed ends, where the rim and a base are respectively located. That is, existing flex-tubes in such devices are cup-shaped rather than truly tubular. This cup configuration allows the wall at and near the rim of the first, annular flex tube member to be moved into operative engagement with the second annular member and still be fixed at its base against rotation.

However, to bring the rim of the flex-tube and the second member into operative engagement requires additional work and power to bend the cup-shaped flex-tube's base and flex its cylindrical wall near the base.

What is needed is a new type of harmonic motor or actuator device having a flexible member which does not rotate, requires less power to operate, and simultaneously reduces the effective gear ratio between the rotor and stator.

### SUMMARY OF THE INVENTION

The present invention provides a harmonic drive device such as a harmonic motor or harmonic actuator having a flex-tube that is tubular rather than cup-shaped, and yet is prevented from rotating during operation of the device. The first tubular, flexible member of the inventive device is provided with inner and outer generally cylindrical surfaces, one of which is provided with gears or threads that respectively inter-engage with gears or threads on the second member to induce linear or rotational movement or the second member, as the case may be. The other of the first member's inner and outer generally cylindrical surfaces is provided with gear teeth or splines that are engaged with identical mating gear teeth or splines on a stationary third member or armature in a circumferentially moving manner. The inter-engagement of the armature, flexible first member and movable second member prevent rotation of the first member during operation of the harmonic motor or harmonic actuator.

In the preferred embodiment of the invention, a harmonic motor includes a first annular member, second and third members, and a device for flexing the first annular member. The first annular member has a longitudinal axis, lies on a plane perpendicular to the longitudinal axis, and is flexible in a direction, which lies in the plane. The second and third members are substantially coaxially aligned with the first annular member and lay in the plane. One of the second and third members is rotatable about the longitudinal axis, and the other or the first and second members is non-rotatable about the longitudinal axis. The flexing device flexes the first annular member to rotate the at least two spaced-apart points of contact with the second member and an additional at least two spaced-apart points of contact with the third member, and sequentially flexes the first annular member to rotate the points of contact with said second and third members about the longitudinal axis which rotates the rotatable one of said second and third members about the longitudinal axis.

Several benefits and advantages are derived from the preferred embodiment of the invention. By using at least two points of contact between the first annular and second members as well as the first annular and third members, the rotatable one (i.e. the rotor) of the second and third members is being driven by at least two points of contact by the non-rotatable one (i.e. the rotor driving member or stator) of the second and third members. Driving the motor with at least two points of contact provides a more robust and more smoothly operating motor than is provided in the prior art, as can be appreciated by the artisan. In addition, mechanical interconnection torque input/output interconnection means directly to the flexible member is avoided.

In another aspect of the preferred embodiment, the first annular member assumes a substantially cylindrical configuration due to its inherent resiliency when the flexing means is not active. This results in mechanical disengagement between the second and third members, preventing any undesirable load back-drive.

These and other features and advantages of this invention will become apparent upon reading the following specification, which, along with the drawings, describes preferred and alternative embodiments of the invention in detail.

### BRIEF DESCRIPTION OF THE DRAWINGS

The present invention will now be described, by way of example, with reference to the accompanying drawings, in which:

FIG. 1A, is a top view of a prior art, cup-shaped flex-spline member for a harmonic device;

FIG. 1B, is a cross-sectional view, taken on lines 1B-1B of FIG. 1A;

FIG. 2, is a schematic diagram of the preferred embodiment of the harmonic motor of the present invention; and

FIG. 3, is a schematic diagram similar to that of FIG. 2, but where the harmonic motor is de-activated.

Although the drawings represent embodiments of the present invention, the drawings are not necessarily to scale and certain features may be exaggerated in order to illustrate and explain the present invention. The exemplification set forth herein illustrates an embodiment of the invention, in one form, and such exemplifications are not to be construed as limiting the scope of the invention in any manner.

### DESCRIPTION OF THE PREFERRED EMBODIMENT

The present invention is intended for application in varied automotive vehicle applications and will be described in that context. It is to be understood, however, that the present invention could be successfully applied in many other applications. Accordingly, the claims herein should not be deemed limited to the specifics of the preferred embodiment of the invention described hereunder.

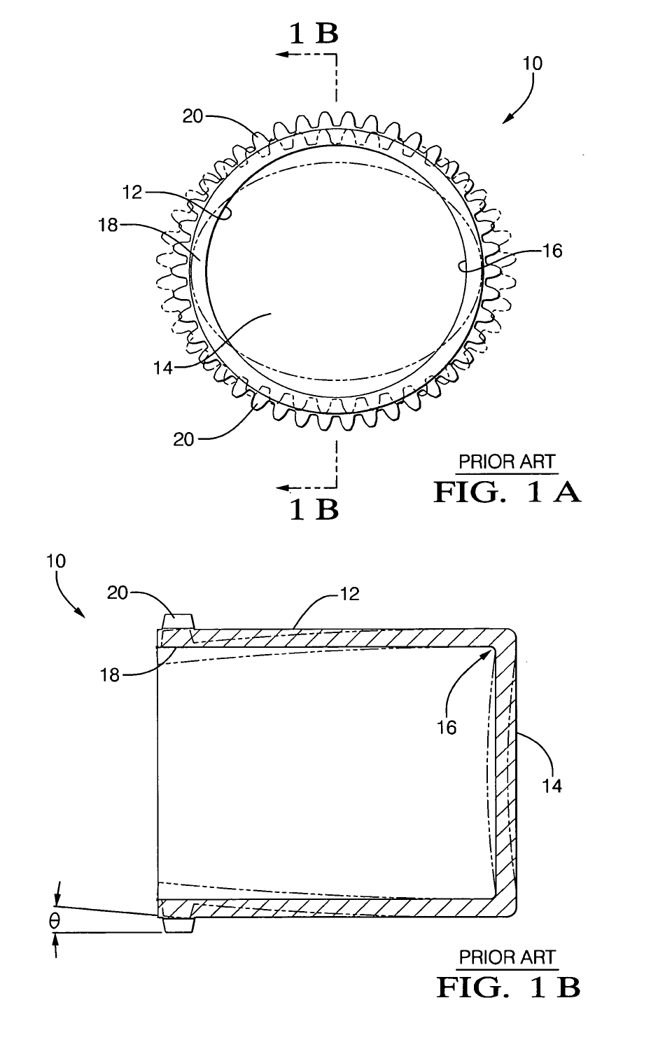

Known harmonic motors and gear systems typically have a cup-shaped flex-spline that, in application, is mechanically coupled to an associated input or output member to transmit forces created by the associated gear system. Referring to FIGS. 1A and 1B, a known cup-shaped flex-spline 10 is illustrated. Flex-spline 10 comprises a cylindrical sidewall 12 and a bottom wall 14 integrally formed therewith. A nominally right angle corner, indicated generally at 16, continuously circumscribes the bottom wall 14. The open upper portion of side wall 12 defines a rim 18 which is thickened to form radially outwardly facing gear teeth 20 extending continuously circumferentially thereabout for engagement with opposed teeth of a mating gear (not illustrated).

Flex-spline 10 is formed with the sidewall 12 assuming a circular configuration when in the unloaded condition. In application, the upper portion of the sidewall 12, including the rim 18 and gear teeth 20, is loaded into an ellipsoid configuration, illustrated in phantom, wherein the rim alternately flexes inwardly and outwardly during rotation of flex-spline 10. Additionally, the bottom wall 14 tends to “oil can” axially inwardly and outwardly at the same time. In addition to imposing high parasitic losses and inefficiencies, the reciprocal “tilting” or bending of the upper portion of the side wall 12 inwardly and outwardly creates stress risers at corner 16 which can work-harden the material, leading to fracture and failure of the mechanism. The only practical design implementation to address this shortcoming is to increase the axial length of the flex-spline 10. Although this partially mitigates the flexing problem, there remains a limit to the axial length of the gear teeth 20, resulting in relatively high force loads and moments which must be reinforced by increasing package size and material costs. Furthermore, the cyclical tilting of the side wall 18 and gear teeth 20 results in rotational misalignment of gear teeth 20 with any mating teeth (not illustrated), thereby increasing unit loading and wear. This rotational misalignment is illustrated as offset angle θ in FIG. 1B.

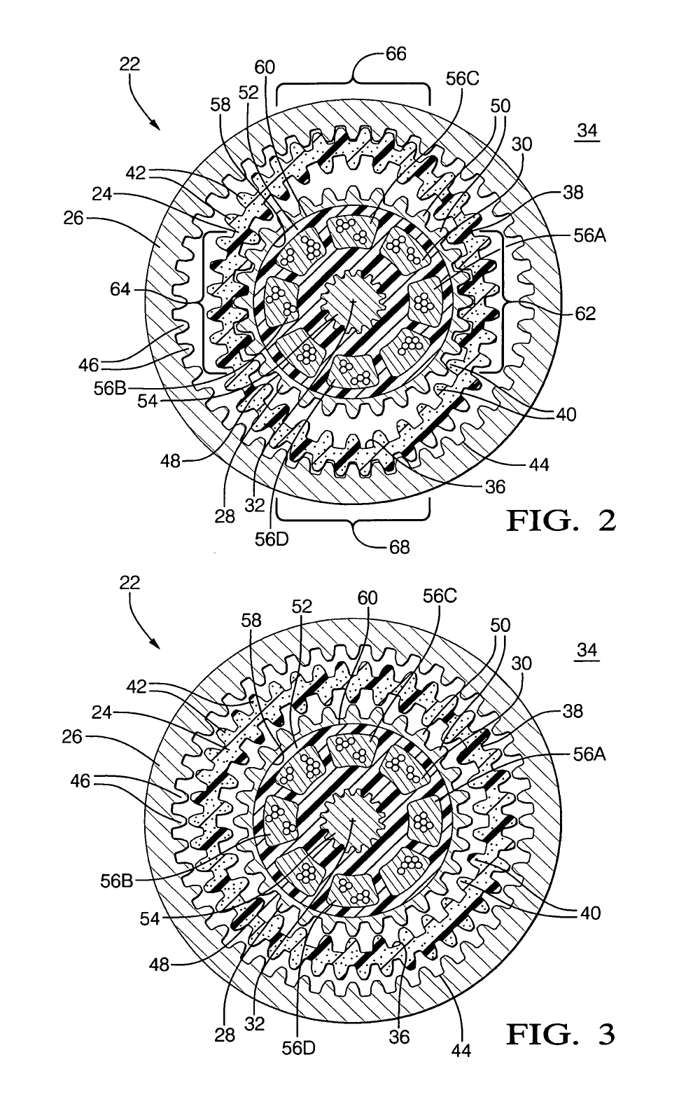

Referring now to FIG. 2, a preferred embodiment of the presently inventive harmonic drive motor 22 is illustrated. The harmonic drive motor 22 includes a first annular member 24, a second member 26, a third member 28 and means 30 for flexing the first annular member 24. The first annular member 24 has a longitudinal axis 32 (seen as a point in FIG. 2). The first annular member 24 lies on a plane 34 corresponding to the plane of the drawing sheet and normal to the longitudinal axis 32.

The first annular member 24 is cylindrically tube-shaped, defining radial inner and outer surfaces 36 and 38, respectively. Both ends of first annular member 24 are parallel to plane 34 and are open in both axial directions. Inner surface 36 forms a plurality of radially inwardly extending gear teeth 40 which are substantially equally circumferentially spaced. Outer surface 38 forms a plurality of radially outwardly extending gear teeth 42 which are substantially equally circumferentially spaced. Gear teeth 40 and 42 are similarly shaped and dimensioned, are mutually parallel and extend the entire axial length of the first annular member 24. First annular member 24 is formed of material, which allows it to be easily flexed radially inwardly and outwardly from its normal or relaxed round configuration illustrated in FIG. 3. For example, first annular member 24 can be a molded composite of hard rubber or reinforced Nylon combined with particles of ferromagnetic material in sufficient quantity to enable localized magnetic attraction/repulsion of regions or circumferential segments of the first annular member 24 to effect deflection thereof as illustrated in FIG. 2. Although flexible radially, the first annular member is relatively rigid in the circumferential direction.

The second member 26 is a nominally round and relatively rigid cylinder having an inwardly facing circumferential surface 44 forming a plurality of radially inwardly extending gear teeth 46 which are substantially equally circumferentially spaced. Gear teeth 46 of second member 26 are shaped and dimensioned to selectively cooperatively engage gear teeth 42 of first annular member 24 as is described herein below. The second member 26 is preferably constructed of aluminum, reinforced Nylon, or other suitable non-ferrous material. The second member 26 is arranged concentrically with first annular member 24 for rotation about longitudinal axis 32. Gear teeth 46 extend the entire axial length of the second member 26 to maximize the operating contact surfaces between cooperating adjacent gears 42 and 46. As is best illustrated in FIG. 3, first annular member 24 and second member 26 are dimensioned to permit radial clearance between the tips of gears 42 and 46, respectively, wherever the first annular member 24 is in the relaxed position.

The third member 28 is a nominally round and relatively rigid cylinder having an outwardly facing circumferential surface 48 forming a plurality of radially outwardly extending gear teeth 50 which are substantially equally circumferentially spaced. Gear teeth 50 of third member 28 are shaped and dimensioned to selectively cooperatively engage gear teeth 40 of first annular member 24 as is described herein below. The third member 28 is preferably constructed of aluminum, reinforced Nylon, or other suitable non-ferrous material. The third member 28 is arranged concentrically with the first annular member 24 about the longitudinal axis 32. Gear teeth 50 extend the entire axial length of the third member 28 to maximize the operating contact surfaces between cooperating adjacent gear teeth 40 and 50. As is best illustrated in FIG. 3, first annular member 24 and third member 28 are dimensioned to permit radial clearance between the tips of gear teeth 40 and 50, respectively, whenever the first annular member 24 is in the relaxed position.

The means 30 for flexing the first annular member 24 is preferably constructed as an electromagnetic actuator assembly, and herein after, is identified as such. Electromagnetic actuator assembly 30 includes a generally cylindrical armature body 52 fixedly mounted to a splined end of an axially elongated support member 54. In application, support member 54 could extend axially in one or both directions beyond the axial ends of the first annular member 24 as well as the second member 26 to fix the electromagnetic stator assembly from displacement or rotation about longitudinal axis. Furthermore, support member can be employed to affix end closure members, seals, output shaft bearings and the like (all non-illustrated), depending upon the particular application intended.

Armature body 52 is generally spool-shaped, including axially leading and trailing outwardly extending flange portions (not illustrated). A plurality of electrical coils or windings 56 are insulatively disposed within armature body 52 and are each electrically in-circuit with a control system via electrical conductors to define a discrete number of circumferentially arranged magnetic poles. Armature body 52 is formed of ferrous material such as laminated or sintered steel or other suitable material. Although eight electrical coils 56 are illustrated, more or fewer can be applied, as the intended application dictates.

The third member 28 has an inwardly facing cylindrical surface 58 which forms an interference fit with an outwardly facing cylindrical surface 60 of armature body 52. Thus, the third member 28 and the electromagnetic actuator assembly 30 are affixed in-assembly as a stator for relative non-rotation with respect to the first annular member 24 and the second member 26.

As best viewed in FIG. 3 where the first annular member 24 is in the relaxed position, i.e. when none of the electrical coils 56 are electrically energized, first annular member assumes a substantially round configuration. Insodoing, radial spaces are established between opposed gear teeth 42 and 46 of first annular member 24 and second member 26, respectively, as well as between gear teeth 40 and 50 of first annular member 24 and third member 28, respectively. In this condition the second member 26 (motor rotor) is entirely mechanically de-coupled from the third member 28 and electromagnetic actuator assembly 30 (motor stator), as well as the first annular member 24.

Referring to FIG. 2, the harmonic motor functions by selectively energizing opposed coil pairs within the actuator assembly 30. For example, if an opposed pair of coils 56C and 56D are energized, they create a magnetic field, which attracts 90° offset portions of the flexible first annular member 24, causing it to distend into an elliptical or egg-shaped configuration. The portions of the first annual member 24 adjacent coils 56A and 56 B are drawn radially inwardly into intimate contact with the outer peripheral surface 48 of third member 28, wherein gear teeth 50 of third member 28 engage gear teeth 40 of first annular member 24. Such points-of-contact or engagement are designated by brackets 62 and 64. Simultaneously, opposed (by 90°) portions of the first annular member 24 are forced radially outwardly into intimate contact with inner surface 44 of second member 26, wherein gear teeth 42 of first annular member engage gear teeth 46 of second member 26. Such points-of-contact or engagement are designated by brackets 66 and 68. This engagement can be supplemented by magnetic repulsion of adjacent reverse polarized coils 56C and 56D.

As illustrated in FIG. 2, second member 26 is interconnected with third member 28 for non-rotation by the first annular member or flex-spline interlock 24. When the electrical coils are sequentially (ex.: circumferentially) energized, the localized points of contact 62 & 64 and 66 & 68 of the cooperating engaged gear teeth “walks around” the circumference of the harmonic motor 22, thereby effecting relative rotation between the second member 26 and the third member 28.

The electrical control of harmonic motors and actuators is well known. For example, U.S. Pat. No. 6,664,711 B2 and U.S. patent Application 2005/0253675 A1 describe harmonic motors and controllers therefore which can be adopted for use in the present invention. U.S. Pat. No. 6,664,711 B2 and U.S. 2005/0253675 A1 are hereby incorporated herein by reference as an exemplary teaching of one possible approach. It is to be understood that they reflect only one of many possible control strategies. Furthermore, other methodologies for sequentially flexing the first annular member such as mechanical, electrical or electromagnetic could be implemented without departing from the spirit of the invention.

In the present harmonic motor, the gear teeth are parallel to the motor axis. This will result in the flex-spline rotating in the same direction as the outer gear since the flex-spline inside gear teeth would have more teeth than the matching armature gear teeth. The overall effect will be an approximate doubling of the motor output torque for the same actuation.

It is to be understood that the invention has been described with reference to specific embodiments and variations to provide the features and advantages previously described and that the embodiments are susceptible of modification as will be apparent to those skilled in the art.

Furthermore, it is contemplated that many alternative, common inexpensive materials can be employed to construct the basis constituent components. Accordingly, the forgoing is not to be construed in a limiting sense.

The invention has been described in an illustrative manner, and it is to be understood that the terminology, which has been used is intended to be in the nature of words of description rather than of limitation.

Obviously, many modifications and variations of the present invention are possible in light of the above teachings. For example, . . . It is, therefore, to be understood that within the scope of the appended claims, wherein reference numerals are merely for illustrative purposes and convenience and are not in any way limiting, the invention, which is defined by the following claims as interpreted according to the principles of patent law, including the Doctrine of Equivalents, may be practiced otherwise than is specifically described.

1. A harmonic drive motor comprising:
a first annular member having a longitudinal axis, wherein the first annular member lies on a plane perpendicular to the longitudinal axis, and wherein the first annular member is flexible along a direction, which lies in the plane; second and third annular members substantially coaxially aligned with the first annular member and lying in the plane; and
means for flexing the first annular member into at least two spaced-apart points of contact with the second annular member and into at least two spaced-apart points of contact with said third annular member, and for sequentially flexing the first annular member to rotate said spaced-apart points of contact about the longitudinal axis to effect relative rotation between said second and third annular members about the longitudinal axis.

2. The harmonic drive motor of claim 1, wherein said at least two spaced-apart points of contact with the second member and said at least two spaced-apart points of contact with the third member are sequentially rotated in a substantially fixed phased relationship.

3. The harmonic drive motor of claim 1, wherein said second and third annular members are substantially rigid.

4. The harmonic drive motor of claim 1, wherein said first annular member is disposed concentrically intermediate said second and third annular members.

5. The harmonic drive motor of claim 4, wherein said first annular member defines inner and outer concentric surfaces.

6. The harmonic drive motor of claim 5, wherein said second annular member defines an engagement surface disposed adjacent one of said first member surfaces, and said third annular member defines an engagement surface disposed adjacent the other of said first member surfaces.

7. The harmonic drive motor of claim 6, wherein said inner and outer concentric surfaces of said first annular member and said engagement surfaces of said second and third annular members define cooperating concentric gear teeth operative to effect localized engagement there between.

8. The harmonic drive motor of claim 7, wherein said gear teeth extend substantially axially and are circumferentially arranged on said surfaces.

9. The harmonic drive motor of claim 7, wherein said gear teeth extend substantially the entire axial length of said annular members.

10. The harmonic drive motor of claim 1, wherein said first annular member has an unflexed substantially circular shape, and wherein said second and third annular members have substantially circular shapes.

11. The harmonic drive motor of claim 10, wherein the first annular member is disposed circumferentially within the second annular member, and the third annular member is disposed circumferentially within the first annular member.

12. The harmonic drive motor of claim 11, wherein the first annular member has gear teeth on its inner and outer surfaces, wherein the second annular member has gear teeth on its inner circumference, and wherein the third annular member has gear teeth on its outer circumference.

13. The harmonic drive motor of claim 12, wherein the first annular member is a harmonic-gear-train flex-spline gear, wherein the second annular member is a harmonic-gear-train outer gear, and wherein the third annular member is a harmonic-gear-train inner gear.

14. The harmonic drive motor of claim 13, wherein the flexing means comprises a multi-pole electromagnetic armature.

15. The harmonic drive motor of claim 13, wherein the flexing means includes an array of spaced-apart magnets disposed on the inner circumference of the flex-spline gear and a magnetic stator carried with said third annular member and spaced apart from the array.

16. The harmonic drive motor of claim 13, wherein the flexing means includes an array of spaced-apart, piezoelectric members disposed on the inner circumference of the flex-spline gear.

17. The harmonic drive motor of claim 13, wherein the flexing means includes an array of spaced-apart, magneto-strictive members disposed on the inner circumference of the flex-spline gear.

18. The harmonic drive motor of claim 1, wherein the flexing means includes an array of spaced-apart magnets disposed on the inner perimeter of the first annular member and a magnetic stator disposed inside and spaced apart from the array.

19. The harmonic drive motor of claim 1, wherein the flexing means includes an array of spaced-apart, piezoelectric members disposed on the inner perimeter of the first annular member.

20. The harmonic drive motor of claim 1, wherein the flexing means includes an array of spaced-apart magneto-strictive members disposed on the inner perimeter of the first annular member.

21. The harmonic drive motor of claim 1, wherein the flexing means comprises a multi-pole electromagnetic armature carried with said third annular member.

22. The harmonic drive motor of claim 1, wherein the third annular member and flexing means are joined as a single assembly.

23. The harmonic drive motor of claim 1, wherein said flexing means is operative to flex said first annular member into a generally elliptical configuration, wherein said at least two spaced-apart points of contact with the second member fall upon the major axis of the ellipse and wherein said at least two spaced-apart points of contact with the third member fall upon the minor axis of the ellipse.

24. The harmonic drive motor of claim 1, wherein said first annular member is flexed into a generally oblong configuration having major and minor axes intersecting said longitudinal axis, wherein said at least two spaced-apart points of contact with said second annular member fall upon one of said axes and wherein said at least two spaced-apart points of contact with said third annular member fall upon the other of said axes.

25. The harmonic drive motor of claim 24, wherein said major and minor axes are disposed substantially normally to one another.

26. A harmonic drive motor comprising:
a generally cylindrical, open ended member defining inner and outer surfaces and having a longitudinal axis, wherein the member lies on a plane perpendicular to the longitudinal axis, and wherein the member is omni-directionally flexible in all directions parallel to the plane;
a generally cylindrical, substantially rigid outer member defining an inner surface radially spaced from said flexible member outer surface;
A generally cylindrical, substantially rigid inner member defining an outer surface radially spaced from said flexible member inner surface; and
means for selectively deflecting said flexible member into a generally ellipsoid-like configuration wherein at least two circumferentially spaced-apart points of said flexible member outer surface contact the inner surface of said outer member and, simultaneously, at least two circumferentially spaced-apart points of said flexible member inner surface contact the outer surface of said inner member, and for sequentially flexing said flexible member to rotate the spaced-apart points of contact about the longitudinal axis to effect relative rotation between said inner and outer members.

27. A harmonic drive motor comprising:
a first annular member having a longitudinal axis, wherein the first annular member lies on a plane perpendicular to the longitudinal axis, and wherein the first annular member in flexible along a direction which lies in the plane;
second and third members aligned with the first annular member and lying in the plane; and
means for flexing the first annular member into at least two spaced-apart points of contact with the second member and into at least two spaced-apart points of contact with said third member, and for sequentially flexing the first annular member to rotate said spaced-apart points of contact about the longitudinal axis to effect relative rotation between said second and third members.
